(19) United States
(12) Patent Application Publication
(10) Pub. No.: US 2010/0270236 A1
(43) Pub. Date: Oct. 28, 2010

(54) DEEP WATER DESALINATION SYSTEM AND METHOD

(76) Inventor: John SCIALDONE, Gulfport, MS (US)

Correspondence Address: FITCH, EVEN, TABIN & FLANNERY, P. O. BOX 18415, WASHINGTON, DC, 20036, US

(21) Appl. No.: 12/766,083

(22) Filed: Apr. 23, 2010

Related U.S. Application Data
(60) Provisional application No. 61/172,102, filed on Apr. 23, 2009.

(51) Int. Cl. C02F 1/44; B01D 65/02; C02F 103/08

(52) U.S. Cl. 210/636; 210/170.11; 210/652

(57) ABSTRACT

A cost effective continuous deep water desalination method and system that can use reverse osmosis, and use the difference in the relative density of fresh and salt water to raise desalinized water through a header into an inshore gathering line. The desalinized water can flow to shore via a gravity-driven elevation change. Inertial energy from the gravity drop can be captured prior to deposit to an aquifer or pumping to the land surface. This energy can be used to help drive the system. Wind, solar, and wave energy can also be captured to provide mechanical or electrical power to assist in driving the system. Back flushing the system can be performed through forcing the fresh water or air back through the system and thus force buildup off the membrane.

### APPLICATIONS/INCORPORATION BY REFERENCE

This patent application is related to and claims priority from provisional patent application No. 61/172,102, filed Apr. 23, 2009, entitled DEEP WATER DESALINATION SYSTEM AND METHOD, the contents of which are hereby incorporated herein by reference in their entirety for all purposes.

### FIELD OF THE INVENTION

The present invention generally relates to desalination processes and, specifically, to a deep water desalination method and system using reverse osmosis, and using the difference in the relative density of fresh and salt water to raise the desalinized water through a header into an inshore gathering line, and to optionally flow to desalinized water to shore via a gravity-driven elevation change, harness inertia energy from the gravity drop prior to deposit to an aquifer or pumping to the land surface, and/or bypass the inshore line and rise the desalinized water to the sea surface for collection, and optionally using wind, solar, and wave energy to provide mechanical or electrical power to assist in driving the system.

### BACKGROUND OF INVENTION

The global need for fresh water is well known. Unfortunately, in most parts of the world, sea water is the most readily abundant source for water. In fact, only about 2.5 percent of water on the planet is fresh water, and only 0.4 percent is available for use (see US 2007/0039860 to Watkins). Converting sea water to usable fresh water (desalination) remains an expensive process. Desalination can involve various 1 distillation or reverse osmosis processes. Both processes can use large amounts of energy and produce concentrated brine as an end byproduct. The cost associated with desalination is increasingly more important as energy costs rise, as well as the need to use energy that limits carbon emission.

Reverse osmosis desalination processes can reduce desalination energy costs by using naturally occurring energy or forces. Such processes can use a membrane submerged to a sufficient depth that naturally occurring water pressure forces fresh water through the membrane, such as cellulose acetate (see generally, U.S. Pat. No. 3,456,802 to Cole). Unfortunately, such processes are typically neither feasible on a large scale, nor are they a long term fresh water solution. For example, typical processes known in the art utilize large complex systems, such as found in U.S. Pat. No. 6,673,249 to Max or U.S. Pat. No. 6,348,148 to Bosley. Other systems use cold deep sea water that is raised to the surface by a vortex and heated through solar panels, then distilled (see U.S. Pat. No. 5,744,008 to Craven). No systems are known to provide methods of retrieving desalinated water from a submerged apparatus by use of natural occurring energy and forces. In fact, in varying degrees, most prior art systems require the input of significant further energy to achieve useful end delivery of the water to shore.

Therefore, while these inventions show advances in the art, there remains a desire and a need in the art to provide a reverse osmosis deep water desalination method and system that can be used for continuous cost effective applications and utilize existing energy sources to reduce overall energy costs.

### SUMMARY OF INVENTION

Accordingly, the present invention provides a cost effective continuous deep water desalination method and system. The present invention deep water desalination processes can use reverse osmosis, and use the difference in the relative density of fresh and salt water to raise the desalinized water through a header into an inshore gathering line, and to optionally flow the desalinized water to shore via a gravity-driven elevation change, harness inertia energy from the gravity drop prior to deposit to an aquifer or pumping to the land surface, and/or bypass the inshore line and rise the desalinized water to the sea surface for collection, and optionally using wind, solar, and wave energy to provide mechanical or electrical power to assist in driving the system.

In one example, the deep water desalination system can have a desalination chamber configured to be held in place to a sea bottom by a support structure and fixed at a depth from sea-surface where reverse osmosis can occur through a semi-permeable membrane that is selectively permeable to prohibit salts; a fresh water riser connected to the desalination chamber; a delivery header connected to the fresh water riser by a valve; a pump in-line with the delivery header and configured to draw water flowing through the semi-permeable membrane into the fresh water riser and through the delivery headed.

In one embodiment, the present invention has a desalination chamber fixed at a specified sea depth and configured to transfer resulting fresh water into a reservoir, then pumped to the surface for use. A back flushing mechanism can be utilized to clear brine and build-up around the membrane surrounding the desalination chamber. Other embodiments can use solar power, wind power, and wave action to provide additional energy to drive the system and provide additional energy savings.

Optional features can include a gathering header connected to the delivery header. The gathering header can be configured to deliver the collected fresh water into a subterranean aquifer or the surface.

Other features can include a reservoir connected between the delivery header and the gathering header. Also, a back flushing header can be connected between the valve and desalination chamber, the valve being configured to selectively allow the collected fresh water to flow from the desalination chamber to the delivery header and from the delivery header to the back flushing header. The pump can be selectively switchable to change the direction of the flow of fresh water within the delivery header.

Other features can include electrical power to drive the pump, the electrical power can be at least on of shore power, wind power, solar power, and/or wave action power.

Other features can include the delivery header angled to allow the collected fresh water to flow towards the gathering header by gravitation force.

Other features can include a source of compressed air to force fresh water into the back flush header.

Other features of the present invention will become more apparent to persons having ordinary skill in the art to which the present invention pertains from the following description and claims.

### BRIEF DESCRIPTION OF THE FIGURES

The foregoing features, as well as other features, will become apparent with reference to the description and figures below, in which like numerals represent elements and in which:

FIG. 1 illustrates a schematic view of a deep water desalination plant according to one embodiment of the present invention.

FIG. 2 illustrates a graph of ocean temperature as a function of depth.

FIG. 3 illustrates a graph of ocean density as a function of depth.

FIG. 4 illustrates a graph of ocean salinity as a function of depth.

FIG. 5 illustrates a topographical map of surface salinity variations around the globe.

FIG. 6 illustrates a graph of required height to obtain osmotic pressure as a function of approximate depth.

FIG. 7 illustrates sample fresh water head pressure at various depths.

FIG. 8 illustrates an optional feature of the present invention, including a gravity drop in-shore delivery header.

FIG. 9 illustrates Depth vs. Power required to pump water to surface with a pump at sixty percent efficiency.

FIG. 10 illustrates an optional feature of the present invention having compressed air assist in back flushing the system.

FIG. 11 illustrates an alternate embodiment of the present invention having compressed air assist in back flushing the system.

FIG. 12 illustrates an embodiment of the present invention having alternate sources of electrical and mechanical power.

### DETAILED DESCRIPTION OF THE INVENTION

The present invention provides a cost effective continuous deep water desalination method and system. The present invention deep water desalination processes can use reverse osmosis, and use the difference in the relative density of fresh and salt water to raise the desalinized water through a header into an inshore gathering line, and to optionally flow the desalinized water to shore via a gravity-driven elevation change, harness inertia energy from the gravity drop prior to deposit to an aquifer or pumping to the land surface, and/or bypass the inshore line and rise the desalinized water to the sea surface for collection, and optionally using wind, solar, and wave energy to provide mechanical or electrical power to assist in driving the system. The present invention provides a significant improvement over the prior art in that it can operate at significantly shallower depths over the known prior art, but can also utilize a variety of naturally occurring forces to further reduce overall energy needed to deliver the fresh water to the surface and to shore.

As provided herein in one embodiment, the present invention significantly advances the art by creating a complete system that both raises purified fresh water from a desalination chamber and into a gathering inshore header, and delivers the water ashore through a method that can effectively and efficiently harness naturally occurring forces resulting from the difference in the relative density of fresh and salt water (harnessed via a riser header from the desalination chamber), and gravity-driven through an inshore pipeline system with a declining elevation from point of origin to point of delivery. Moreover, the overall system can capture inertia energy from the inshore flow of water in the gathering pipeline that can be harnessed to compress air and/or generate electricity. These auxiliary energy capturing systems can be employed to aid in, for example, back flush of the desalination chambers or otherwise add power to run other parts of the system. A further significant benefit of the present invention can be the virtual static operation all submerged devices. This reduction in moving parts is beneficial for reducing maintenance in the harsh marine environment, while protecting the core components from the sometimes harsh conditions experienced at the sea surface.

Accordingly, in the present invention, the practical utility and usefulness barriers associated with the significant water depths, energy requirements, and complex infrastructure known in art can be reduced or eliminated. Generally, this is achieved through a simplified infrastructure, significantly reducing the depth requirement and collecting the fresh water end product at an endpoint in a manner that can utilize naturally occurring forces and pressure differentials. The present invention can also provide for the continuous shore-ward flow of the fresh water end product via a gathering and delivery header, which can utilize gravity as a driving force through a progressive decrease in elevation. This flow can begin after desalinized/purified (and less dense) water is naturally driven out of the desalination chamber, continuing up through a riser pipe to the gathering header. The gathering header can be located at a depth below the point of pressure equilibrium in the system, such that there remains approximately 2-6 PSI of force (depending on the depth of the desalination chamber) used to drive the initial induction of fresh water into the gathering header at the junction between the riser pipe and the in-shore delivery line.

In general, the present invention uses a desalination chamber submerged to a depth as provided below and having a riser pipe to allow the outflow of the lower density fresh water up to a gathering header. Continued delivery of the fresh water to shore can terminate to a natural sub-surface aquifer or storage chamber via a delivery line which gradually declines in elevation, thus utilizing gravity as the shore-ward driving force.

The system dynamics of the gravitational drop can add additional energy from inertia generated from the flow of water shore-ward. Part or all of this inertial energy can be harvested through a mill, turbine, or similar device placed in the inshore line ahead of the final point of delivery. A further advantage of the gravitational drop is that the downstream flow of water in the inshore delivery line can create a “siphon effect” on the riser and the desalination chamber. In other words, the siphon effect would lower the pressure inside the desalination chamber and, therefore, cause the overall system to perform as though it were placed at a lower depth (i.e., was under greater outside sea pressure). Ultimately, this could be used to improve system efficiency and may allow for the desalination chamber to be placed at a shallower depth than a system that does not utilize this gravity drop aspect of this embodiment for the inshore gathering line. Optionally, the overall system could be modified to accommodate this siphon force (and work in shallower depths) by “reverse charging” the system from land with fresh water and then allowing it to start flowing back in shore again, so as to develop the lower internal chamber pressure.

Thus, if the desalination chamber were placed at a shallower depth that would otherwise not provide the outside sea water pressure to drive through the chamber walls and begin the process of reverse osmosis, then the procedure of reverse charging the system could trigger the start up of the process by filling the gathering line, riser header, and desalination chamber with fresh water. Once filled, and upon releasing the reverse charge of pressure from shore needed to fill the system, the water in the inshore delivery line would begin to again flow back to shore due to the gravity-driven inertia, which is harnessed from the declining elevation of the inshore line. This process would, in turn, draw a vacuum in the delivery line, riser header and, ultimately, the desalination chamber itself and, therefore, create the effect of a higher pressure outside the desalination chamber, thus triggering reverse osmosis and the beginning of a continuous cycle where the lower density fresh water will rise in the header and also be drawn into the inshore line by the steady inshore flow through the delivery pipeline.

The desalination chamber can be cleared of particulate buildup by a variety of methods, including a separate header which is pressurized from the water surface directly above or in the vicinity of the chamber and utilizing either vessel, buoy, or platform-based mechanical equipment. This same equipment base could also be used to support bypassing the inshore gathering header and assist with pumping the fresh water to the surface via pumps, which can be powered by natural occurring energy sources such as wind, solar, or wave action power. Alternatively, the system can be back flushed from a shore-based pumping system, which is connected to the inshore delivery line and reverses the flow of the system temporality in order to clear the desalination chamber walls.

In one embodiment, the present invention has a desalination chamber fixed at a specified sea depth and configured to transfer resulting fresh water into a reservoir, then pumped to the surface for use. A back flushing mechanism can be utilized to clear brine and build-up on the membrane surrounding the desalination chamber. Other embodiments can use solar power, wind power, and wave action to provide additional energy to drive the system and provide additional energy savings.

Thus, the system of the present invention, at its core, provides a system and method of desalination using ocean pressure to drive reverse osmosis. It can be configured using supplemental or natural energy that could potentially allow shallower operation under lower pressures, or it can employ natural materials, such as cellulose acetate membranes.

Benefits of the present invention are, for all intents and purposes, an unlimited supply of pressure and raw materials in the same location (i.e., the pressure and raw sea water are in the same location), a simple design limiting the need for complex mechanical systems operating at the desired operating depths, and unlimited ability to dilute the brine created in a back flush of the system.

In designing the present invention, the osmotic pressure needed to force fresh water from salt water (i.e., reverse osmosis) can be determined using the following equation: Pₛ=CRT, where Pₛ is osmotic pressure, C is the ionic molar concentration, R is 0.082 (liter*bar/degree*mole) ((gas-constant)), and T is the absolute temperature in Kelvin. Conditions may vary among various environments, but for present calculations, “T” can be 300 K (27 degrees C. or 80.6 degrees F.); “C” can be the typical salt concentration of seawater, which is 1.1 mole/liter. This results in a corresponding osmotic pressure Pₛ=1.1×0.082×300=27 bar. 27 bar=391.60 psi.

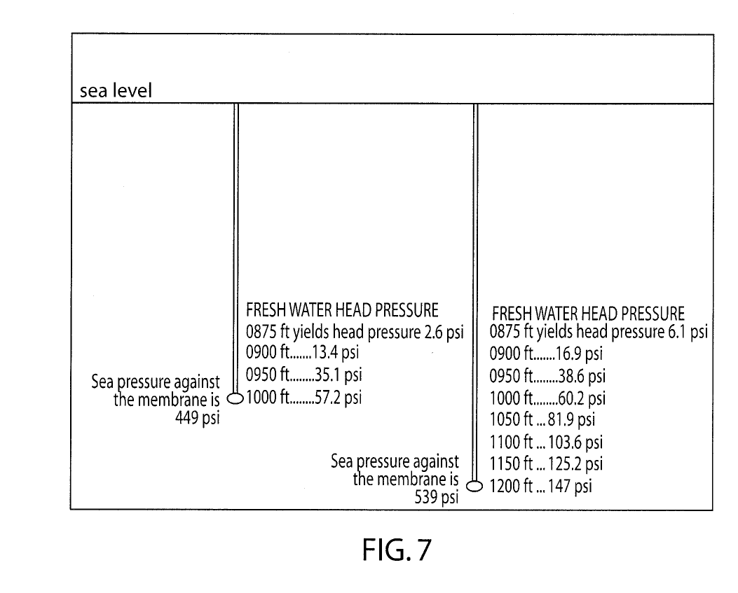

The formula to determine pressure needed to reach osmotic equilibrium is as follows: P=(ρ)h. To derive feet, 144 is added to the equation; thus, P=((ρ)h)/144=h=((144)P)/(ρ). Applied therefore: h=((144)(392))/64.7 or h=872 feet. Thus, 872 feet (approximately 266 meters) is the equilibrium point, so that reverse osmosis would occur at a depth below 266 meters, given these variable assumptions. FIG. 7 illustrates sample fresh water head pressure at various depths using these calculations. The two sets of numbers differ in that each assumes a different depth for the desalination chamber. They demonstrate that the deeper the desalination chamber is placed, the greater the distance' the fresh water can be driven up through the riser header or the greater the pressure that can be achieved at the junction of the riser and the inshore delivery pipeline.

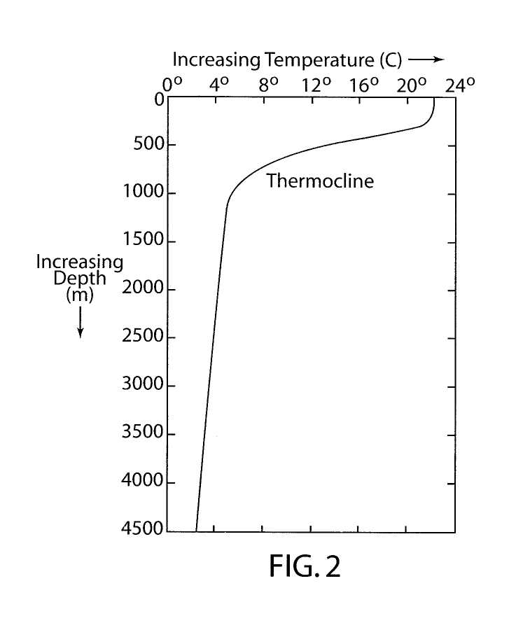

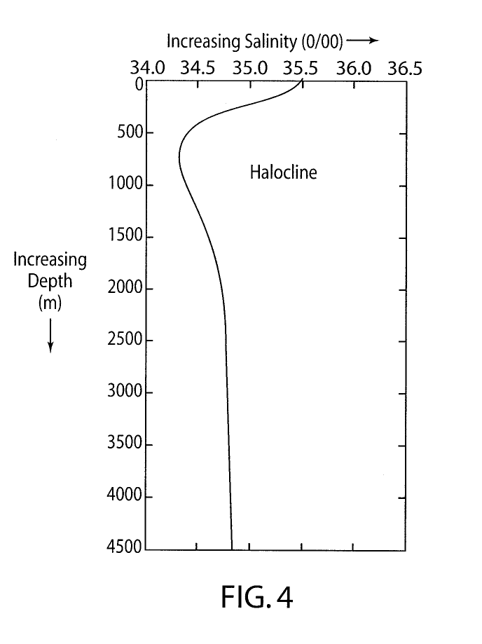

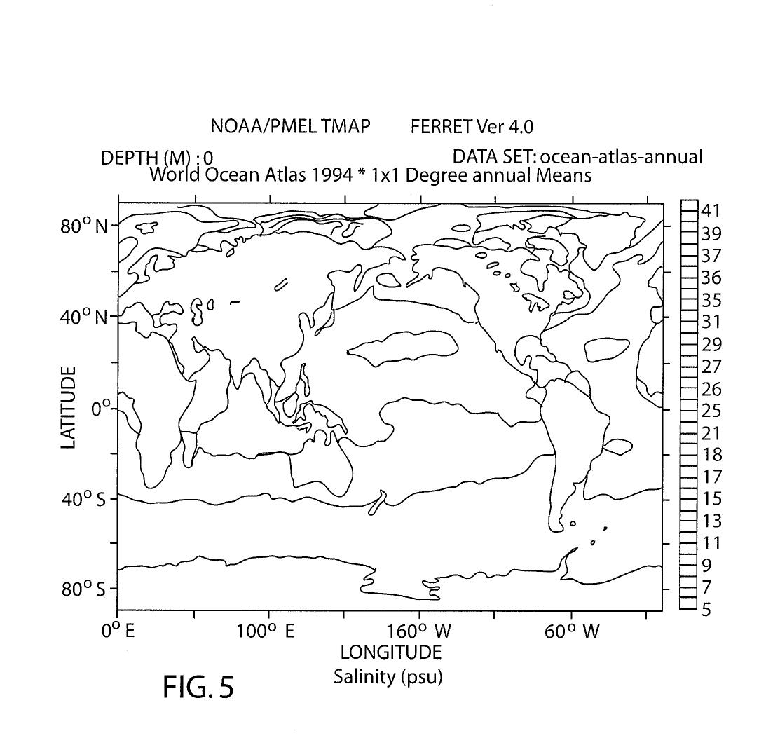

Optimal depth calculations can also consider looking at variations in sea water by temperature, density, and salinity as shown in FIGS. 2, 3, and 4 respectively. (Source: www.windows.ucar.edu/tour/link=/earth/Water/density.htm/&edu=high). Also, salinity variation could be considered by comparing variations around the world at the surface. FIG. 5 shows a topographical mapping of changes in salinity around the globe. The units for salinity (psu) stands for practical salinity units. Practical salinity units can be approximately converted to molarity (mol/L) by calculating the following:

$$psu = \frac{g\_sea \_salt}{L\_sea \_water}$$

$$35 psu * \frac{1 g\_Cl}{1.80655 g\_sea \_salt} * \frac{1 mol\_Cl}{35.45 g\_Cl} = 0.9394 M$$

(Source: http://antoine.frostburg.edu/chem/senese/1 01 /solutions/faq/salinity-and-molarity. shtml)

A range of concentrations was calculated using this equation and shown in Table 1. Specifically, Table 1 shows the calculation of a range of molar concentrations of sea water. The range of psu was determined from the map in FIG. 5.

TABLE 1

| Concentration | molarity |
|---|---|
| 33 | 0.88575 |
| 33.2 | 0.891118 |
| 33.4 | 0.896487 |
| 33.6 | 0.901855 |
| 33.8 | 0.907223 |
| 34 | 0.912591 |
| 34.2 | 0.917959 |
| 34.4 | 0.923328 |
| 34.6 | 0.928696 |
| 34.8 | 0.934064 |
| 35 | 0.939432 |
| 35.2 | 0.9448 |
| 35.4 | 0.950168 |
| 35.6 | 0.955537 |
| 35.8 | 0.960905 |
| 36 | 0.966273 |
| 36.2 | 0.971641 |

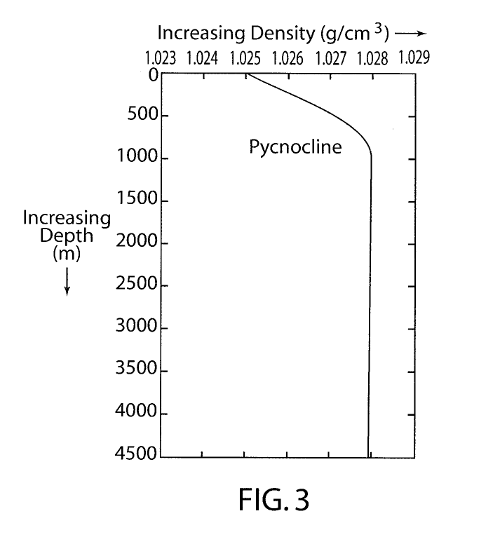

Table 2 illustrates approximated values of density at certain depth and corresponding data in English units. The approximations use the plot illustrated in FIG. 3.

TABLE 2

| | |
|---|---|
| Density | Density-Depth |
| Depth Plot | (English Units) |

| Depth | Density (ρ) | Depth | Density |
|---|---|---|---|
| m | g/cm\hat{ }3 | ft | lb/ft\hat{ }3 |
| 0 | 1.025 | 0 | 63.987675 |
| 300 | 1.026 | 874 | 64.050102 |
| 600 | 1.027 | 1968 | 64.112529 |
| 900 | 1.028 | 2952 | 64.174956 |

Table 3 approximates values for temperature from FIG. 2 and corresponding data in ft and K.

TABLE 3
Depth Temperature Plot

| Depth | Temp | Depth | Temp |
|---|---|---|---|
| m | Deg. C. | ft | K |
| 2000 | 4 | 6560 | 277 |
| 700 | 8 | 2296 | 281 |
| 550 | 12 | 1804 | 285 |
| 450 | 16 | 1476 | 289 |
| 300 | 20 | 984 | 293 |
| 0 | 22 | 0 | 295 |

Calculations to determine the required height to obtain osmotic pressure are shown in Table 4.

TABLE 4

| | | | | Osmotic | Osmotic | | | Required |
|---|---|---|---|---|---|---|---|---|
| Molarity | | | Approx | Pressure | Pressure | Density | Density | Height |
| (C.) | R | Temp (T) | Depth | (Ps) | (Ps) | (ρ) | (ρ) | (h) |
| mole/L | (L * bar)/(K * mol) | Kelvin | ft | bar | psi | g/cm\hat{ }3 | lb/ft\hat{ }3 | ft |
| 0.953 | 0.082 | 295 | 250 | 23.05307 | 334.3617 | 1.025 | 63.99 | 752 |
| 0.947 | 0.082 | 295 | 500 | 22.90793 | 332.2566 | 1.0253 | 64.01 | 748 |
| 0.94 | 0.082 | 293 | 750 | 22.58444 | 327.5647 | 1.0256 | 64.03 | 737 |
| 0.94 | 0.082 | 292 | 1000 | 22.50736 | 326.4467 | 1.0258 | 64.04 | 734 |
| 0.932 | 0.082 | 291 | 1250 | 22.23938 | 322.56 | 1.026 | 64.05 | 725 |
| 0.925 | 0.082 | 288 | 1500 | 21.8448 | 316.837 | 1.0263 | 64.07 | 712 |
| 0.92 | 0.082 | 285 | 1750 | 21.5004 | 311.8418 | 1.0265 | 64.08 | 701 |
| 0.92 | 0.082 | 284 | 2000 | 21.42496 | 310.7476 | 1.0268 | 64.1 | 698 |
| 0.92 | 0.082 | 283 | 2250 | 21.34952 | 309.6534 | 1.027 | 64.11 | 695 |
| 0.925 | 0.082 | 281 | 2500 | 21.31385 | 309.1361 | 1.0273 | 64.13 | 694 |
| 0.925 | 0.082 | 279 | 2750 | 21.16215 | 306.9358 | 1.0275 | 64.14 | 689 |
| 0.925 | 0.082 | 278 | 3000 | 21.0863 | 305.8357 | 1.028 | 64.17 | 686 |

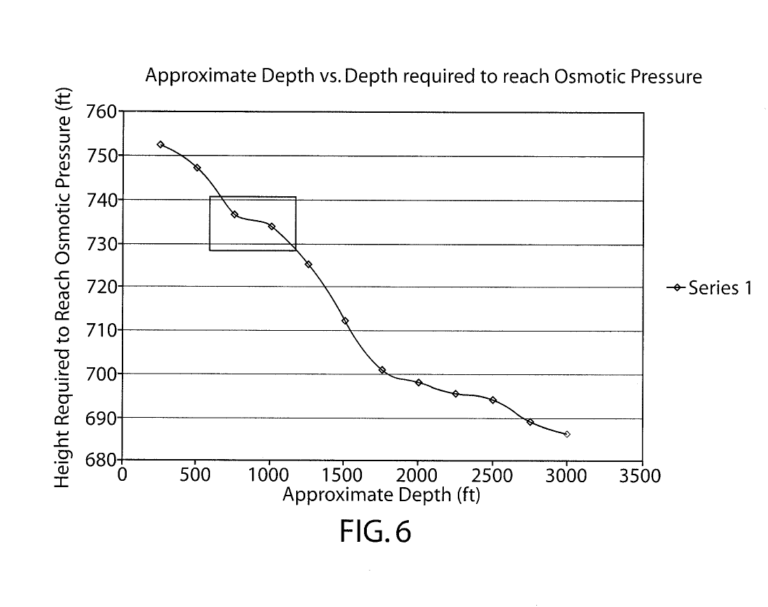

Approximate depth values were chosen arbitrarily. Temperature, density, and salinity were all approximated using FIGS. 2, 3, and 4. Salinity values were converted to molarity using Table 1. The approximate depth and required height values were used as source data in FIG. 6. The Equations used to calculate osmotic pressure:

$${P}_{s} = RTC$$

$$h = \frac{{P}_{s}}{ρ}$$

Where: Pₛ=osmotic pressure; R=constant (0.082); T=temperature (Kelvin); C=molarity; h=height required to obtain osmotic pressure; and ρ=density

FIG. 6 shows a plot of required height to obtain osmotic pressure against the approximate depth. The rectangle highlights the approximate region in which the required height is close to the approximate depth. This region represents the optimum depth to perform the operation for desalination of the present invention.

As shown, at greater depths, the osmotic pressure is lower and, thus, the required height to reach osmotic pressure is smaller. The osmotic pressure is lower at greater depths because of the decreased temperature, increased density, and decreased concentration. Around 750 feet (229 m), the required depth to reach osmotic pressure is approximately 735 feet (224 m). This could be the optimum location for the process because the pressure at this depth is approximately equal to the osmotic pressure. Anywhere above this level, the pressure caused by depth could be lower than the osmotic pressure and, below this level, the pressure caused by depth could exceed what is necessary and add to the energy costs associated to delivery of the fresh water to shore. Applying this information would suggest that, for most applications, the present invention would work best at densities below 686-752 ft (209-229 m).

The present invention method and system operating at these depths can use the difference in density to allow the fresh water to permeate a membrane and to rise in a header to a gathering line and then use the effect of gravity to flow the water shoreward through a pipeline that drops in elevation over its length. Supplemental energy would be needed to bring the water to the surface (assuming the application is not to simply dump to or replenish an underground aquifer). Nevertheless, the energy needed to bring the fresh water to the surface would not be significantly greater (or less) than what is needed to pump well water from an existing aquifer a comparable depth to the inshore line.

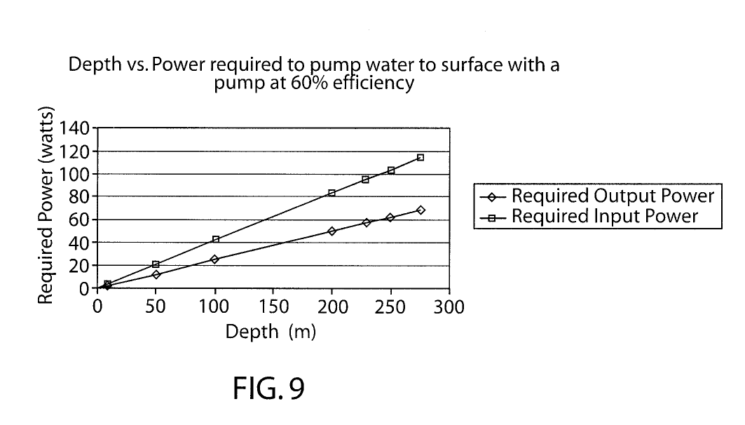

Table 5 below and FIG. 9 illustrate the power (where power=work per unit mass) required to pump water to surface with a pump as a function of depth, assuming sixty percent efficiency. This efficiency rating is arbitrary, though it is a standard efficiency known in the art. The values are calculated using the following formula: p=rho*g*h (where: rho=1025, g=9.81, and h=200-500).

TABLE 5

| | | | | Required | | |
|---|---|---|---|---|---|---|
| | | | | Output | | |
| | Depth | g | Density | Power | Pump | Required Input power |
| Pressure (Pa) | (m) | (m/s\hat{ }2) | (kg/m\hat{ }3) | (watts) | Efficiency | (watts) |
| 0 | 0 | 9.81 | 1000 | 0 | 0.6 | 0 |
| 2765194 | 275 | 9.81 | 1000 | 67.44375 | 0.6 | 112.4063 |
| 2513813 | 250 | 9.81 | 1000 | 61.3125 | 0.6 | 102.1875 |
| 2298630 | 228.6 | 9.81 | 1000 | 56.06415 | 0.6 | 93.44025 |
| 2011050 | 200 | 9.81 | 1000 | 49.05 | 0.6 | 81.75 |
| 1005525 | 100 | 9.81 | 1000 | 24.525 | 0.6 | 40.875 |
| 502762.5 | 50 | 9.81 | 1000 | 12.2625 | 0.6 | 20.4375 |
| 100552.5 | 10 | 9.81 | 1000 | 2.4525 | 0.6 | 4.0875 |
| 10055.25 | 1 | 9.81 | 1000 | 0.24525 | 0.6 | 0.40875 |

These data can be used as a basis to calculate the energy savings of the present invention when utilizing several natural occurring forces which, alone or in any combination, are an improvement in the amount of power needed over the known prior art.

Aside from the depth predictions described above, advances in porous materials may permit reverse osmosis to occur at lower pressure than are required today (thus requiring an even lower depth), or the use of more durable or less expensive natural materials (such as porous rock) might require greater pressure but more durable in the harsh deep sea environment. This may still be viable once the cost of generating that pressure is eliminated or at least reduced.

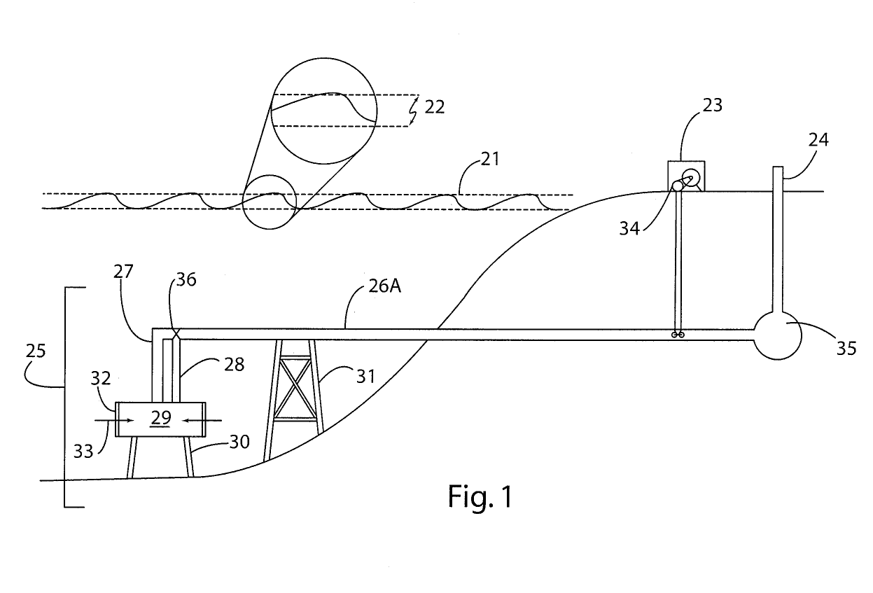

As the system is used, the membrane can accumulate brine and other buildup. If untreated, this buildup would gradually reduce efficiency of the system and would eventually cause the system to fail. Thus, a periodic clearing of the brine buildup on the membrane would be necessary. This could be accomplished by a potential scrubber or back flushing feature. A back flushing feature would need to reverse system pressure to force water in the opposite direction, thereby forcing the buildup from the membrane. The periodicity of this back flushing or other membrane cleaning system could be calculated by comparing reduced system efficiency with the energy needed to clean the membrane. The energy to develop the pressure required to back flush should be the same as currently employed in land-based or surface applications, although the energy required to generate that pressure at the depth of the desalination chamber could be greater. The systems to create the back flush pressure could be local, such as by placing an inline pump in the gathering inshore line. Or, the pressure could be external, such as using a system mounted to a service vessel, which connects to the back flush header shown in FIG. 1 and described more fully below.

In an alternate embodiment, the back-flushing mechanism could also use compressed air to force buildup from the desalination chamber. In this embodiment, compressed air could be developed (at least in part) using energy from the inshore flow inertia of the water to drive a turbine which can drive, in whole or in part, an air compressor. Compressed air could be stored in land-based tanks and delivered to desalination chamber 9 through a separate line back to the riser pipe. During a back flush, the fresh water riser 28 would be isolated from the inshore gathering line by a remote activate shut-off valve. The top of the riser column could be pressurized from a shore tank air line to a point that exceeds ambient sea pressure, thereby driving the water back down into the desalination chamber to result in a back flush purge.

An alternative method would be to simply generate more energy from a greater volume of compressed air and use the same method, but back flush directly from the inshore gathering line. Obviously, the benefit to this last step is it creates a virtually energy-independent system to effect the otherwise energy-intensive process of reverse osmosis, water delivery, and back flush.

The energy requirements for the system and method of the present invention can be determined using sound engineering principles and consider variables of the diameter of an inshore gathering pipe, the rate of inclination, distance traveled, the flow rate of water entering the line, and the like. The principal being that the water will gain inertia as it flows “downhill” up to a static level given the other variables, then some of the energy transferred to a power takeoff mill in the same way that a dam (e.g., hydroelectric) works.

For illustrative purposes only, Table 5 shows the energy needed to drive the system after passing through the membrane. As shown, the table compares riser pipe head pressures shown in FIG. 1 and assumes a 20 foot inside diameter line. Further assumption includes a rate of decline of 10 feet every 20 miles. As shown, the energy/flow rate is shown at various lengths of 5, 10, 20, and 30 miles. This gravitational advantage can offset the energy needed to deliver the fresh water to a determined delivery point, since some of the remaining energy in the flow rate after the power takeoff mill could be used to assist in driving the water back to surface. Other offsets to total energy needed to be added back into the system to deliver the water to a delivery point are to use wave action, wind turbines, and solar panels. Wave action could be used to not only generate electricity, but also to provide a mechanical force to lift the water to the surface.

Turning now to FIG. 1, a schematic representation of one embodiment of the present invention is shown for illustrative purposes only. As shown, the system has a desalination chamber 29 held in place to the sea bottom by support structure 30. Placement of the overall zone of operation 25 is fixed at a depth from sea-surface 21, where reverse osmosis can occur through a semi-permeable membrane 32 that is selectively permeable to prohibit, for example, salts such as sodium and chloride ions. Fresh water is permitted through membrane 32 as demonstrated at 33. It is noted that other types of materials may also be selectively permeable so long as the natural sea pressure is sufficient to drive the reverse osmosis (see FIGs. and tables described above). It is also noted that area 22 affected by wave action can also be considered in determining depth and potential to capture wave action energy. Once the fresh water (permeate) passes through membrane 32, it is collected within desalination chamber 29 until it is lifted out through fresh water riser 28. The force to lift the fresh water out of chamber 29, as illustrated, can be assisted through a pump 34 driven by electric generator 23. It is noted that pump 34 can also be located at various other positions within the system as dictated by sound engineering practices, and the electrical generator can be powered by local electrical service, wind turbines, solar panels, wave action turbines, or any of a number of combinations of these sources or other sources known in the art. Pump 34 may also be driven by mechanical action of waves to lift the water, as is found in prior art mechanical well pumps. As shown, power take off mill 37 can also be used to capture energy by inertia.

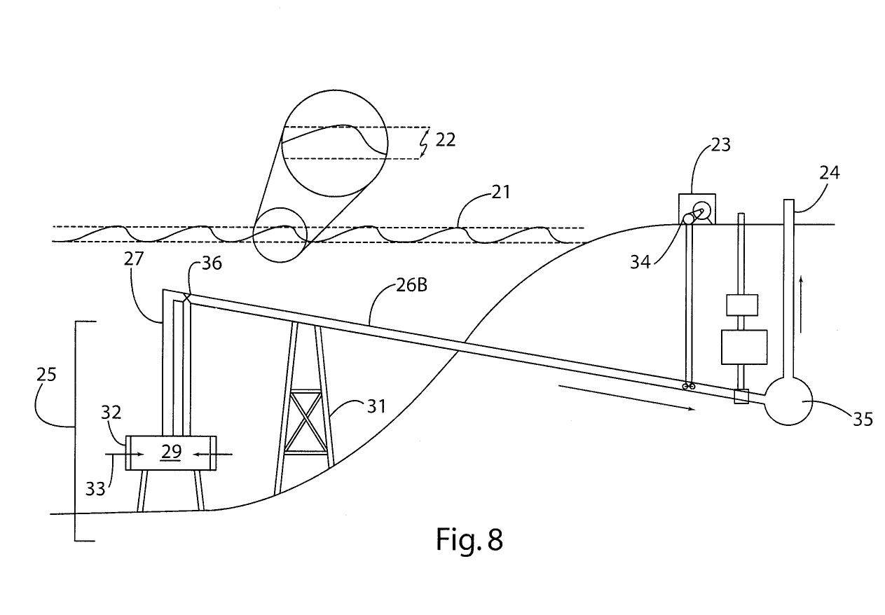

Collected fresh water can be drawn to a reservoir 35 or immediately to a delivery point 24 at ground level through a gathering inshore delivery header 26 (26A as shown in FIG. 1). Delivery header 26 can follow the contours of the sea bottom or run horizontally into the ground to a delivery point 24. In an alternate embodiment, delivery header 26b can slope in a downward direction, as is illustrated in FIG. 8, at at least one or several points. The inertia of the gravity drop of fresh water can be captured at various points along the delivery header 268 or as it reaches reservoir 35. This inertia can be captured by an electric turbine to add energy to further drive the system. The delivery header 26 can be supported as needed by a delivery support system 31.

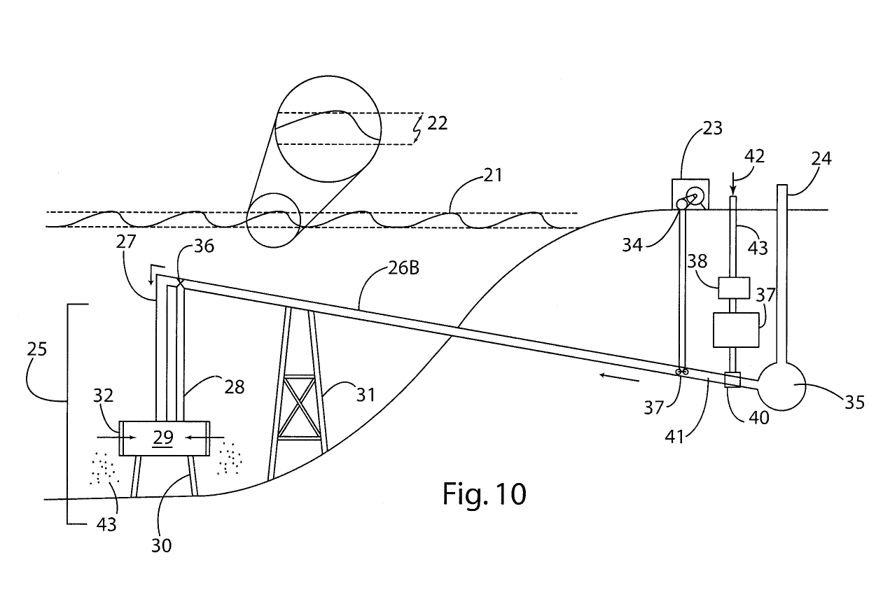

As the system is used, brine and other material unable to pass through the membrane can accumulate on the area surrounding membrane 32. This will require occasional cleaning of the surface of the membrane to maintain the efficiency of the system as described above. Membrane 32 can be physically scrubbed or back-flushed. As illustrated, pump 34 can be reversed (or a separate pump added as in FIG. 10 described below) to provide sufficient pressure to drive water in reverse through membrane 32, thus forcing accumulations off its surface. As illustrated, a valve 36 can close off the delivery system at various points along its path, and a back-flush header 27 can deliver the reverse pressurized fresh water out of the desalination chamber. Frequency of this process would vary, but consideration would be made to maintain optimal efficiency of the system. Frequency of the system could also be determined by timers, sensors, predetermined reduction in flow rate, or manually, which could be based on visual indicators or other means known in the art.

FIG. 10 shows an alternate embodiment where the back flushing system has a separate system to force compressed air back through delivery header 268. In this embodiment, pump 34 is turned off and fresh water is allowed to flow in reverse through the pump. Valve 36 is opened to drain into back flusher header 27 and block fresh water riser 28. Also, valve 40 closes the delivery header 268 towards reservoir 35 while opening one-way access from fresh air header 43. Once valve 40 is activated in this way, air-compressor 38 (in-line with fresh air header 43) can be activated by drawing in fresh air at point 42 and introducing compressed air toward the delivery header 268. Fresh air header 43 can optionally have a compressed air reservoir 39. As shown, compressed air at 41 forces the fresh water back towards the membrane 32 and ultimately, while in operation, back through membrane 32, thus forcing buildup 43 back into the sea water.

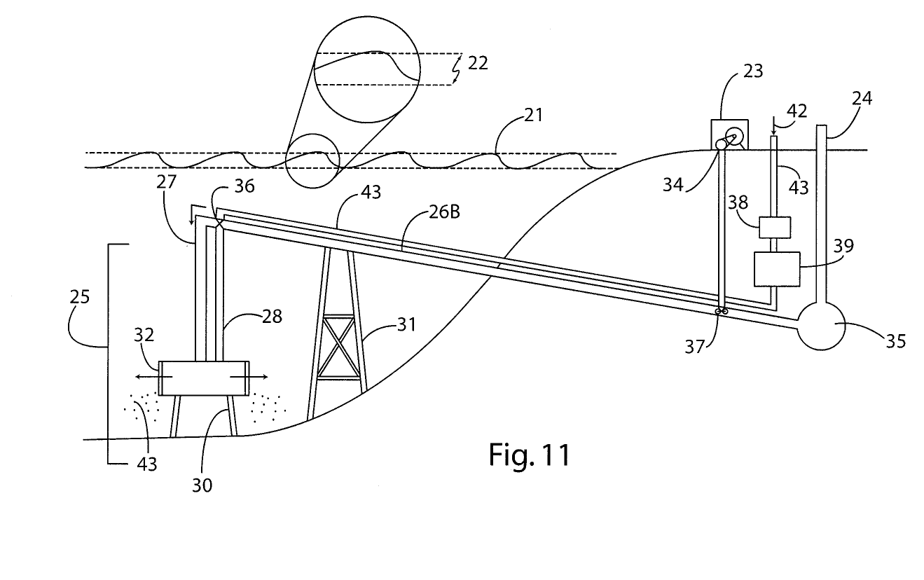

FIG. 11 shows an alternate embodiment that fresh air header 43 delivers the compressed air to valve 36 which is, in this embodiment, also configured to deliver the compressed air into back flusher 27. Many other configurations of back-flushing are possible and still fall within the scope of the present invention.

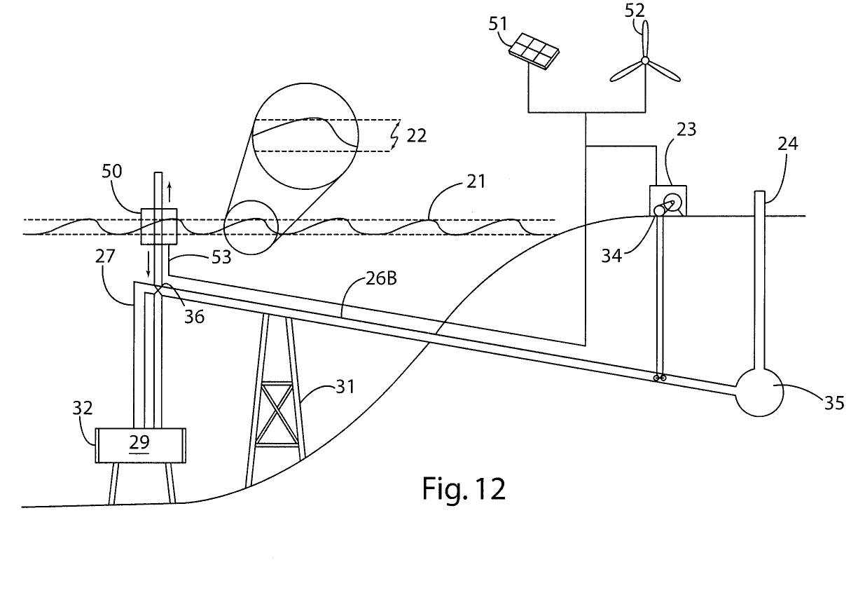

FIG. 12 shows optional features to reduce overall energy costs to deliver the fresh water to gathering header 24. As shown, a floating or fixed platform can be positioned to capture the movement of the wave action 22 near the site of the system, either by mechanical or electrical means. As shown, wave-action hydroelectric plant 50 (known in the art, see generally U.S. Pat. No. 4,843,250) can be used to supply energy via line 53 that can be used to drive pump 34. Also, solar panels 51 and wind turbine 52 can be used to supplement shore electrical energy. It is noted that the wave action and wind energy can also be translated into mechanical force to pump fresh water towards gathering header 24, as is known in the art for shallow land-based wells.

While the invention has been described in conjunction with specific embodiments, it is evident that many alternatives, modifications, and variations will be apparent to those skilled in the art in light of the foregoing description. Accordingly, the present invention attempts to embrace all such alternatives, modifications, and variations that fall within the spirit and scope of the appended claims.

I claim:

1. A deep water desalination system, comprising:
a desalination chamber configured to be held in place to a sea bottom by a support structure and fixed at a depth from sea-surface where reverse osmosis can occur through a semi-permeable membrane that is selectively permeable to prohibit salts;
a fresh water riser connected to the desalination chamber;
a delivery header connected to the fresh water riser by a valve;
a pump in-line with the delivery header and configured to draw water flowing through the semi-permeable membrane into the fresh water riser and through the delivery headed.

2. The system of claim 1, further comprising a gathering header connected to the delivery header.

3. The system of claim 2, wherein the gathering header is configured to deliver the collected fresh water into a subterranean aquifer.

4. The system of claim 2, wherein the gathering header is configured to deliver the collected fresh water to the surface.

5. The system of claim 2, further comprising a reservoir connected between the delivery header and the gathering header.

6. The system of claim 1, further comprising a back flushing header connected between the valve and desalination chamber, the valve being configured to selectively allow the collected fresh water to flow from the desalination chamber to the delivery header and from the delivery header to the back flushing header; and
he pump is selectively switchable to change the direction of the flow of fresh water within the delivery header.

7. The system of claim 1, further comprising electrical power to drive the pump, the electrical power selected from the list of: shore power, wind power, solar power, and wave action power.

8. The system of claim 1, wherein the delivery header is angled to allow the collected fresh water to flow towards the gathering header by gravitation force.

9. The system of claim 6, further comprising a source of compressed air to force fresh water into the back flush header.

10. A desalination method of seawater comprising the steps of:
providing a force sufficient to push sea water through a membrane (e.g., cellulose acetate, porous rock, and the like) through reverse osmosis, the force being provided by placing the desalination chamber at a depth (e.g., 209-229 m) range sufficient to drive reverse osmosis so that fresh water is forced through the membrane, the membrane selectively permeable to prohibit passage of at least salts such as sodium and chloride ions;
collecting the permeate in a desalination chamber;
lifting the permeate through a fresh water riser to a height sufficient to allow at least one gravity drop to a permeate reservoir;
flowing the permeate down the gravity drop to the permeate reservoir;
capturing the energy [turbine] of the inertia of the permeate from the gravity drop when the permeate reaches the permeate reservoir; and
lifting the permeate to a delivery point.

11. The method of claim 10, wherein the lifting force is supplied by at least one of electric, wind, solar, or wave action power.

12. The method of claim 10, further comprising the step of cleaning the membrane by back-flushing or physical scrubbing of the membrane.
